(19) United States
(12) Patent Application Publication
(10) Pub. No.: US 2008/0217590 A1
(43) Pub. Date: Sep. 11, 2008

(54) PHOTOCHROMIC MATERIAL AND PROCESS FOR ITS PREPARATION

(75) Inventors: VALERY ALEXANDROVICH BARACHEVSKY, MOSKAU (RU); WERNER JENNINGER, KOLN (DE); BORIS ISAAKOVICH ZAPADINSKIY, MOSKAU (RU); ANTON OSKAROVICH AIT, MOSKAU (RU); ALEXANDER ALEXANDROVICH DYNAEV, MOSKAU (RU); ALLA VASILIEVNA KOTOVA, MOSKAU (RU); IRINA ALEXANDROVNA MATVEEVA, MOSKAU (RU); LARISA ALEXANDROVNA PEVZOVA, APRELEVKA (RU); VALENTINA TROFIMOVNA SHASHKOVA, MOSKAU (RU); YURII PETROVICH STROKACH, DOLGOPRUDNY (RU); OLGA VLADIMIROVNA VENIDICTOVA, MOSKAU (RU)

Correspondence Address: NORRIS, MCLAUGHLIN & MARCUS, P.A., 875 THIRD AVE, 18TH FLOOR, NEW YORK, NY, 10022, US

(73) Assignee: BAYER MATERIALSCIENCE AG, LEVERKUSEN (DE)

(21) Appl. No.: 11/941,317

(22) Filed: Nov. 16, 2007

(30) Foreign Application Priority Data
Nov. 17, 2006 (DE) 10 2006 054 236.3

(51) Int. Cl. G02B 5/23; C08F 2/48

(52) U.S. Cl. 252/586; 427/508; 427/162

(57) ABSTRACT

A curable composition which has photochromic properties and is based on an acrylic compound which can undergo free-radical polymerization, a cured product which is obtained by thermal or photochemical curing of this curable composition on a substrate, e.g. polycarbonate glass with triplex formation (three-layered structure), and a process for the preparation of an optical material are described.

The present invention relates to a curable composition having photochromic properties, a cured product which is obtained by thermal or photochemical curing of this curable composition on a substrate, e.g. polycarbonate glass with triplex formation (three-layered structure), and a process for the preparation of an optical material. In particular, the invention relates to a curable photochromic acrylic composition which can advantageously be used as an intermediate substance which is capable of imparting to an optical material, such as e.g. a polycarbonate triplex, readily photochemical properties by insertion of a composition between polycarbonate glasses, a cured product therefrom, an optical material and a process for the preparation of optical material.

### BACKGROUND OF THE INVENTION

Photochromic triplexes, duplexes and films which are based on polymer compositions which comprise a certain amount of organic compounds which change color under incident light, which in general takes place on the basis of reversible chemical transfer reactions, e.g. ring opening and renewed cyclization reactions, are currently known. The photochromic organic compound can be used for coating a base material, e.g. a polymeric organic base material, or this can be added to it by various processes. Such processes include (see e.g. US 2006/0033088 A):
a process for dissolving or dispersing a photochromic organic compound in the base material, for example a process in which a photochromic organic compound is added to a monomeric base material before polymerization of the monomeric base material;
a process in which a photochromic organic compound is absorbed into a base material by impregnation or convection of the base material in a high-temperature solution of the photochromic organic compound;
a process in which a photochromic organic compound is provided as its own layer between adjacent layers of base material, for example as part of the polymer film;
a process in which a photochromic organic compound is applied to the surface of a base material.

The photochromic organic compounds are most widely used in combination with polymerizable oligomers and monomers (U.S. Pat. No. 6,926,510, U.S. Pat. No. 5,910,516, U.S. Pat. No. 5,621,017, US 2006/0023160 A, US 2006/0055070 A, US 2006/0033081 A, EP 1 433 814 A).

A common and critical disadvantage of all the known products based on photochromic organic compounds is the limited life which results from irreversible photochemical processes. While in some cases, e.g. in the case of cheap sunglasses, the useable life (up to two years) is acceptable, the useful life required in most other photochromic uses, such as such as lenses, protective screens, glass elements in buildings and vehicles and triplexes, rules out the use of photochromic organic compounds.

Moreover, when photochromic organic compounds are used in polymerizable compositions, they tend to interact with the initiators of the photochemical or thermal curing, which impairs the photochromic properties and obstructs the process for the production of photochromic objects (e.g. US 2006/0055070 A). To eliminate this effect, the processes for obtaining photochromic objects need to be designed in a significantly more complicated manner.

At the same time, photochromic silicate glasses are currently generally known, and are distinguished by their ability to darken under the action of actinic radiation, substantially ultraviolet radiation, and to become colorless when the source of excitation disappears. The photochromism of such glasses in general develops as a result of the formation of a microcrystalline phase of silver halides in the glass (conventionally after thermal after-treatment of the glass). Since such glasses have generally been known for over 30 years (U.S. Pat. No. 3,208,860), they have been employed with modifications in a number of various ways, depending on whether optimization of one or the other photochromic features is required for the particular use (see e.g. U.S. Pat. No. 6,177,371, U.S. Pat. No. 6,165,922, U.S. Pat. No. 6,162,749). It is significant that photochromic silicate glasses are distinguished by a unique photostability in sunlight. In general, the decisive properties of photochromic glasses for various uses are the following: their color and their degree of light transmission in the clear state (without actinic radiation), their color (conventionally grey or brown) and light transmission in the colored form under the action of actinic radiation, the low deviations in the degree of light transmission in the darkened state as a function of temperature, conventionally between 0 and 40° C., and their capacity for reversible depolarization after removal of the exciting light source.

The best photochromic properties are observed with photochromic glasses which contain light-sensitive AgCl microcrystals commercially available from Corning as Photobrown®/Photogray® Extra, Photobrown®/Photogray® Sunsitive, Photobrown® 16/45, Photogray® 16, Photogray® Thin & Dark, XDF Dark Gray).

Photochromic silicate glasses PHG-5 based on light-sensitive CuHal microcrystals have moreover been developed (A. V. Dotsenko, L. B. Glebov, V. A. Tsekhomsky “Physics and Chemistry of Photochromic Glasses”, CRC Press, Boca Raton, N.Y., p. 190 (1998). In contrast to photochromic glasses containing AgHal, CuHal glasses darken not only under UV radiation, but also under visible light and infra-red light. They can consequently show the best light-induced changes.

However, the use of the abovementioned photochromic silicate glasses is complicated by their high weight, the risk of injury after breakages and the required processing at very high temperatures (above 1,000° C.).

The abovementioned disadvantages are overcome by Applicants' discovery of a hitherto unknown hydride-silicate/polymer glasses.

It is an object of the present invention to provide a curable liquid composition of acrylic oligomers which has a filler content of a powder of silicate glass impregnated with an inorganic photochromic compound, which can impart to a cured product excellent photochromic properties, in particular in respect of the long-term use of photochromic objects together with color development intensity and a high blowing speed, as well as excellent adhesion to a substrate.

A further object of the present invention is to provide a photochromic cured product having the above characteristic properties.

A further object of the present invention is to provide a photochromic optical material which comprises the photochromic cured product of the present invention on a substrate.

A further object of the present invention is to provide a photochromic polycarbonate triplex, which is formed by thermal and/or photochemical curing of the above-described acrylic composition between polycarbonate glasses.

A further object of the present invention is to provide a process for the production of a photochromic cured product, which can provide a photochromic cured product having an excellent useful life.

Other objects and advantages of the present invention can be realized from the following description.

### SUMMARY OF THE INVENTION

According to the present invention, the above objects and advantages are achieved by a curable composition which comprises at least the following:
A) 20 to 98.99 wt. % of at least one acrylic compound which can undergo free-radical polymerization,
B) 1.0 to 70 wt. % of a powder of a silicate glass which contains an inorganic photochromic compound,
C) 0.01 to 10 wt. % of a polymerization initiator.

In the following, for short, component A) is also called “binder” and component B) is called “filler”.

The invention also provides a photochromic cured product which is obtained by curing of the curable composition of the invention.

The invention also provides a photochromic optical material which comprises at least one substrate which has a surface coated with a cured product of the curable composition of the invention.

The invention furthermore provides a process for the preparation of a photochromic optical material which comprises at least one substrate which has a coated surface, characterized in that a film of the curable composition of the present invention is formed on at least one surface of a substrate and is cured with light or heat or both light and heat.

The invention moreover provides a process for the preparation of a photochromic optical material, in which a layer of a curable composition according to the invention is subjected to a thermal and/or photochemical curing between at least two polycarbonate glasses.

The present materials and processes for obtaining them have no equivalents in the prior art.

In particular, the polycarbonate triplexes developed can be used for any of the uses heretofore served by photochromic optical materials based on photochromic organic compounds, and especially advantageously for the production of transparent objects intended for long-term use, such as glass in buildings, vehicle and aircraft windows, protective screens, head coverings, motor-bike helmets, in particular windshields etc.

### DETAILED DESCRIPTION

What has been developed and has no equivalents in the prior art is the set-up for the formation of photochromic materials using a polymerizable composition of acrylic oligomers and silicate glass powder coated with an inorganic photochromic compound. The main advantage of this set-up is that a relatively simple oligomer technique can be used to obtain photochromic optical materials with a practically unlimited duration of use. The processability of the photochromic compound at least, in contrast to that of organic photochromic compounds, no longer represents a limiting factor.

The first particular object and main object is the formation of an acrylic composition which, after curing, results in a polymer having a refractive index which is as close as possible to that of inorganic glass coated with an inorganic photochromic compound.

A further particular object is the choice of compositions according to the minimum thermal coefficient of the refractive index, since the refractive index of polymers is greatly temperature-dependent, but the transparency of the optical material should remain without fail at least in the region of room temperature ±20° C.

A further particular object relates to the establishing of the optimum size and form of photochromic glass particles of the filler, in order to achieve the required degree of filler content and the wettability by oligomers, as a result of which the transparency of the optical material is retained.

In achieving this and other objects, it is advantageous to employ adhesion promoters between the polymer and glass.

A further particular object is the development of a process for obtaining a crosslinked optical material, since the polymerization process is accompanied by a change in the refractive index of the binder, and to retain the approximation between the refractive indices of binder and filler it must be ensured that the double bonds in the binder components are used up as far as possible.

Finally, the development of a process for obtaining optical materials represents a very important particular object, since distribution of a super-fine filler in a viscous matrix where the materials have very different densities can lead to the formation of air inclusions which are difficult to remove. as well as to sinking or settling of the filler during the process.

To achieve an approximation between the refractive indices of binder A) and filler B), a mixture of polymerizable compounds is employed in the present invention. In particular, the binder comprises:
20 to 80 wt. % of oligomer A1) having two (meth)acryl groups, in particular of the structure (I), of low refractive index (in particular below 1.51);
5 to 50 wt. % of oligomer A2) having two (meth)acryl groups, in particular of the structure (II), of high refractive index (in particular above 1.53);
optionally a plasticizer D)—an oligomer, in particular one of the structure (III) with a structure related to the oligomer (I), but having either no (meth)acryl groups or at most only one (meth)acryl group;
1 to 30 wt. % of a polymerizable solvent E) (also called monomer or reactive diluent);
   and
from 0.01 to 30 wt. % of an initiator C) of low refractive index for thermal and/or photochemical polymerization.

Any desired known compound can be used as oligomer A1) if it has two (meth)acryl groups which are bonded via a divalent radical having only one aromatic grouping per oligomer.

An oligomer A1) of low refractive index of the formula (I):

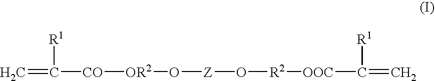

wherein
R¹ is a hydrogen or a fluorine atom or a methyl group;
R² is a divalent organic radical group:

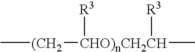

wherein
R³ is a hydrogen atom or a methyl group; and
n is an integer from 0 to 10;
Z is a divalent organic radical group with an ester, carbonate or urethane grouping:

—Y—R⁴—Y—,

wherein
Y is the divalent group —CO—, —COO—, or —CONH—R⁵—NHCO—;
R⁴ is a divalent organic radical group:

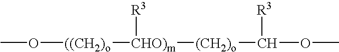

wherein
o is an integer from 1 to 3, m is an integer from 1 to 250;
R⁵ is a divalent organic radical group:

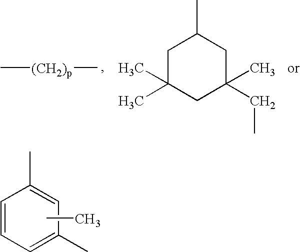

where
p=4 to 12, preferably 6
is preferred.

Preferred oligomers A1) of low refractive index are represented by the following formula (Ia):

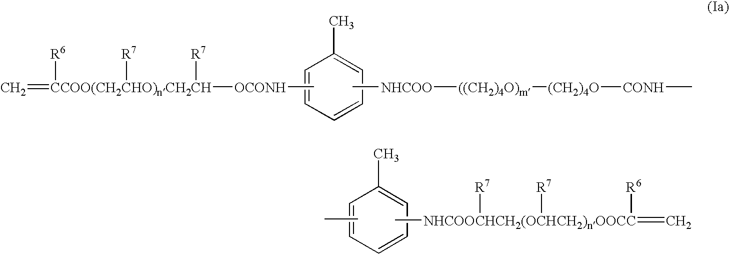

in which R⁶=CH₃, R⁷=H, n′=0, m′=15 to 20 or
in which R⁶=H, R⁷=CH₃, n′=3 to 5, m′=15 to 20 or
in which R⁶=CH₃, R⁷=CH₃, n′=3 to 5, m′=15 to 20.

The abovementioned compounds may be synthesized e.g. by reacting a macro-diisocyanate based on oligotetrahydrofuran-α,ω-diol and having a molecular weight of about 1,400 with ethylene glycol monomethacrylate (abbreviated OUM) or with oxypropylene glycol mono(meth)acrylates (Bisomer™, PPA5S or PPM5S).

Particularly preferred examples by way of illustration of oligomer A1) include, in addition to those mentioned above, polyalkylene glycol di(meth)acrylates, such as e.g. polyethylene glycol di(meth)acrylates having an average molecular weight of from 300 to 1,500, polypropylene glycol di(methyl)acrylates having an average molecular weight of from 375 to 700, polytetramethylene glycol di(meth)acrylates having an average molecular weight of from 500 to 1,500 and perfluoroheptylethylene glycol di(meth)acrylates having an average molecular weight of from 500 to 600.

Any desired compound can be used in particular as oligomer A2) as long as it has two (meth)acryl groups which are bonded by a divalent radical having at least one aromatic grouping per (meth)acryl group.

Preferred examples by way of illustration of oligomer A2) of high refractive index include those of the formula (II):

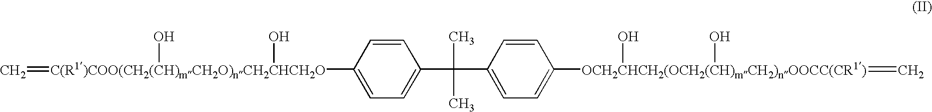

wherein R^{1′} is a hydrogen atom or a methyl group, n″ is an integer from 1 to 20 and m″ is an integer from 0 to 1.

Possible particularly preferred oligomers A2) of high refractive index are bis-GMA and ethoxylated or glycerolated analogues thereof of the corresponding general formulae IV to VI:

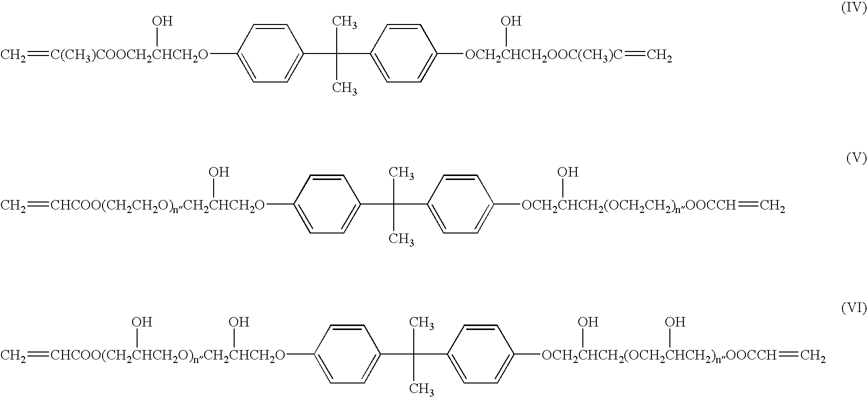

wherein n″ has the meaning given above.

The curable compositions of the present invention can comprise plasticizers D) in addition to the above bifunctional oligomers A1) and A2). In view of the characteristic properties, such as e.g. polymer network density and subsequently elasticity of the cured material, this is preferred.

These compounds have been synthesized specifically (see examples), in order to obtain highly flexible, crosslinked optical materials, which is desirable for use of the compositions of the present invention e.g. as an inner layer of polycarbonate triplexes. In many other uses, the use of plasticizers can be dispensed with. A preferred plasticizer D) can be obtained by the process developed for OUM synthesis, 33, 66 or 100 mol % of the telogen MEG being replaced by an equimolar amount of non-polymerizable monool (subsequently oligomers OUM-1, OUM-2 and OUP), as shown by the Examples which follow. By way of example, these are represented by the compounds of the formula III

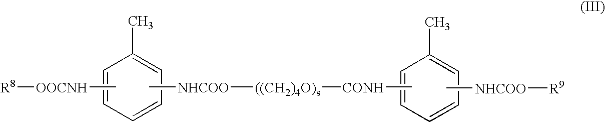

wherein R⁸ and R⁹ independently of one another represent —(CH₂)₂OOCC(CH₃)═CH₂ or a linear or branched C₁ to C₁₈-alkyl radical, preferably —CH(CH₃)₂, or a C₅ to C₁₂-cycloalkyl radical, but the group —(CH₂)₂OOCC(CH₃)═CH₂ occurs only at most once in formula (III), and s represents 15 to 20.

The novel curable composition particularly preferably comprises, as polymerizable solvent E) monomers which can undergo free-radical polymerization in addition to the above bifunctional oligomers A1) and A2). In respect of the characteristic properties, e.g. composition viscosity, properties (solvent resistance, hardness and heat resistance) of a cured product or the photochromic properties after curing, such as color development intensity, blowing speed and stability, this is preferred.

The monomers useful as polymerizable solvent E) which can undergo free-radical polymerization are not subject to any particular limitations, and any desired known compounds having a group which can undergo free-radical polymerization, e.g. a (meth)acryloyl group, (meth)acryloyloxy group, vinyl group, allyl group or styryl group, can be used. Of these, compounds having a (meth)acryloyl group or (meth)acryloyloxy group as the group which can undergo free-radical polymerization are preferred because of their easy availability and stability.

Particularly preferred monomers include acrylate and methacrylate compounds, such as cyclohexyl (meth)acrylate (CHMA), octyl (meth)acrylate, methyl methacrylate, butyl methacrylate, benzyl (meth)acrylate, 2-hydroxyethyl methacrylate and oxypropylene glycol monomethacrylate; thioacrylate and thiomethacrylate compounds, e.g. methyl thioacrylate, benzyl thioacrylate and benzyl thiomethacrylate; and vinyl compounds, e.g. styrene, chlorostyrene, methylstyrene, α-methylstyrene dimer, bromostyrene and N-vinylpyrrolidone.

The quantitative content of the components of the binder of the present invention is determined by the particular need to obtain an optical photochromic material which has a refractive index which is close to that of the inorganic glass filler. In general, the content of the components of the binder can vary widely (e.g.):

| | |
|---|---|
| oligomer A1) | 20 to 80 parts |
| oligomer A2) | 5 to 50 parts |
| plasticizer D) | 0 to 40 parts |
| polymerizable solvent (monomer) E) | 1 to 30 parts. |

The preferred crosslinking binder compositions are as follows:

| | |
|---|---|
| oligomer A1) | 40 to 60 parts |
| oligomer A2) | 15 to 30 parts |
| plasticizer D) | 0 to 40 parts |
| polymerizable solvent (monomer) E) | 10 to 30 parts |

The process for obtaining a photochromic cured product by curing the curable composition according to the invention is not subject to any particular limitations, and known polymerization processes can be used. The polymerization can be started by using a free-radical polymerization initiator C), e.g. from peroxides and azo compounds, the action of UV light, α-radiation, β-radiation or γ-radiation or a combination thereof.

In this context, any desired known free-radical polymerization initiator C) can be used. Conventional examples of a thermal polymerization initiator include diacyl peroxides, such as e.g. benzoyl peroxide, p-chlorobenzoyl peroxide, decanoyl peroxide, lauroyl peroxide and acetyl peroxide; peroxy esters, such as e.g. t-butyl peroxy-2-ethylhexanoate, t-butyl peroxydicarbonate, cumyl peroxyneodecanoate and t-butyl peroxybenzoate; percarbonates, such as e.g. diisopropyl peroxydicarbonate, di-2-ethylhexyl peroxydicarbonate and di-sec-butyloxy carbonate; and azo compounds, such as e.g. 2,2′-azobisisobutyronitrile, 2,2′-azobis(4-dimethylvaleronitrile), 2,2′-azobis(2-methylbutyronitrile) and 1,1′-azobis(cyclohexane-1-carbonitrile).

The amount of the thermal polymerization initiator, which varies according to the polymerization conditions, initiator type and the nature and composition of the polymerizable components, is preferably 0.01 to 10 parts by weight per 100 parts by weight of the total amount of all the other polymerizable components. The above thermal polymerization initiators can be employed by themselves or as a combination of two or more thereof.

If the curable composition according to the invention is polymerized by the action of light, e.g. by UV radiation, the photopolymerization initiator is preferably benzoin, benzoin methyl ether, benzoin butyl ether, benzophenol, acetophenone, 4,4′-dichlorobenzophenone, diethoxyacetophenone, 2-hydroxy-2-methyl-1-phenylpropan-1-one, benzyl methyl ketal, 1-(4-isopropylphenyl)-2-hydroxy-2-methylpropan-1-one, 1-hydroxycyclohexyl phenyl ketone, 2-isopropylthioxanthone, bis(2,6-dimethoxybenzoyl-2,4,4-trimethylpentyl)phosphine oxide, bis(2,4,6-trimethylbenzoyl)phenylphosphine oxide, 2,4,6-trimethylbenzoyldiphenylphosphine oxide or 2-benzyl-2-dimethylamino-1-(4-morpholinophenyl)butan-1-one, diphenyl-(2,4,6-trimethylbenzoyl)phosphine oxide and 2-hydroxy-2-methylpropiophenone (abbreviated to PI).

The photopolymerization initiator can be employed by itself or as a combination of two or more thereof. It can moreover be used together with the above thermal polymerization initiator.

According to the invention, the photochemical curing of acrylic compositions is preferably carried out using a mixture (1:1) of diphenyl-(2,4,6-trimethylbenzoyl)phosphine oxide and 2-hydroxy-2-methylpropiophenone (abbreviated to PI).

The photopolymerization initiator is preferably employed in an amount of from 0.01 to 5 parts by weight per 100 parts by weight of the total amount of all the polymerizable components (monomers and oligomers).

A particularly preferred polymerization process includes curing of the curable composition of the present invention, which comprises the above photopolymerization initiator, by the action of UV radiation and subsequent heating, in order to complete the polymerization.

If the curable composition of the present invention is polymerized by the action of light, such as e.g. UV light, any desired known UV light source can be used. Examples by way of illustration of the UV light source include very high pressure mercury vapor lamps, high pressure mercury vapor lamps, low pressure mercury vapor lamps, xenon lamps, arc lamps, bactericide lamps, metal halide lamps and electrodeless lamps. The irradiation time using the above light source can be suitably determined according to the type, absorption wavelength and sensitivity of the photopolymerization initiator and the thickness of the photochromic layer.

In most of the example described below, a high pressure mercury vapor lamp having an output of 1,000 W was used for the photochemical initiation.

Abbreviations for the composition components often used in the following are given in Table 1.

TABLE 1
Oligomers (monomers) - Components of binders

| Sample | |
|---|---|
| name | Chemical compound |
| MEG | Ethylene glycol monomethacrylate |
| PPM5S | Oxypropylene glycol monomethacrylate (Bisomer ™ PPM5S) |
| OUM | Oligourethane based on MEG and macro-diisocyanate from |
| | oligotetrahydrofuran (see text) |
| OUM-1 | As OUM, but prepared from a mixture of MEG and |
| | isopropanol in the ratio 0.66:0.33 (see text) |
| OUM-2 | As OUM-1, but in the ratio of MEG and |
| | isopropanol = 0.33:0.66 (see text) |
| OUM-3 | Oligourethane based on PPM5S and macro-diisocyanate from |
| | oligotetrahydrofuran (see text) |
| bis-PEA | Bisphenol A ethoxylate diacrylate |
| bis-PGA | Bisphenol A glycerolate diacrylate |
| CHMA | Cyclohexyl methacrylate |
| N-VP | N-Vinylpyrrolidone |
| BZMA | Benzyl methacrylate |
| OUP | Oligourethane based on isopropanol and macro-diisocyanate |
| | from oligotetrahydrofuran (see text) |
| OMA | Octyl methacrylate |
| Adhesive | 3-(Methacryloylpropyl)triethoxysilane |
| PI | Photoinitiator - mixture of diphenyl(2,4,6- |
| | trimethylbenzoyl)phosphine oxide and 2-hydroxy-2- |
| | methylpropiophenone |
| ABN | Thermal polymerization initiator - azobisisobutyronitrile |
| PPA5S | Oxypropylene glycol monoacrylate (Bisomer ™ PPA5S) |

The refractometric properties of some base components of the composition are given in Table 2:

nᵢₙᵢ²⁰: refractive index at 20° C. before curing
n_{hard}²⁰: refractive index at 20° C. after curing

Δn=n_{hard}²⁰−nᵢₙᵢ²⁰

Anᵢₙᵢ: =change of refractive index with temperature before curing
An_{hard}: =change of refractive index with temperature after curing

TABLE 2
Refractometric properties of base components and binders and their
homopolymers

| | | | Δnᵢₙᵢ * 10⁴ | | Δn_{hard} * 10⁴ | |
|---|---|---|---|---|---|---|
| No. | Oligomer | n²⁰ᵢₙᵢ | degree⁻¹ | n²⁰_{hard} | degree⁻¹ | Δn |
| 1 | OUM | 1.5027 | 3.67 | 1.5150 | 2.93 | 0.0123 |
| 2 | OUM-1 | 1.5018 | 3.73 | 1.5138 | 3.13 | 0.0120 |
| 3 | OUM-2 | 1.5028 | 3.47 | 1.5100 | 3.43 | 0.0072 |
| 4 | OUM-3 | 1.4882 | 3.97 | 1.4981 | 3.20 | 0.0099 |
| 5 | bis-PEA | 1.5357 | 3.90 | 1.5592 | 1.87 | 0.0235 |
| 6 | bis-PGA | 1.5581 | 3.87 | 1.5740 | 1.30 | 0.0159 |

*Curing conditions: 1% PI, Hg lamp, 1,000 W, 2 min from each side of the sample

Oligomers A1) and A2) have a relatively broad range of refractive indices, and it is possible to obtain a composition with a predetermined refractive index, for example that of the inorganic glass filler. The low Δn values are typical of all the homopolymers discussed above, and the Δn_{hard} are close to the parameters for oligomers. This means that the curing of oligomers A1) and A2) is accompanied by very low shrinkage, and therefore takes place without noticeable internal stresses in the cured optical material, including the interfaces between the matrix and filler.

The Δn_{hard} values for the cured polymer structure A2) (1.8710-4 and 1.310-4 for cured bis-PEA and bis-PGA) are lower compared with those for the OUM polymers, so that these polymers are distinguished by a relatively low thermo-optical action, while the oligomers of structure II have low Δnᵢₙᵢ and Δn values (Δn=0.0159), which is closely connected with the parameters for OUM. This correlation between the refractometric parameters for oligomers of low and high refractive index shows about the same shrinkage during the polymerization.

The refractometric properties of some curable compositions without a filler content, by way of example, are given in Table 3.

TABLE 3
Refractometric properties of acrylic binders and cured optical materials

| | Binder | Curing | | Δnᵢₙᵢ * 10⁴ | | Δn_{hard} * 10⁴ | | Tₕₒₘ, |
|---|---|---|---|---|---|---|---|---|
| No. | composition, % | conditions* | n²⁰ᵢₙᵢ | degree⁻¹ | n²⁰_{hard} | degree⁻¹ | Δn | ° C. |
| 1 | OUM, 52-55 | PI, 1.1-1.2 | 1.5015 | 3.80 | 1.5249 | 2.83 | 0.0234 | 23 |
| | bis-PGA, 20-21 | | | | | | | |
| | PPM5S, 8.5-9.0 | | | | | | | |
| | CHMA, 15-18 | | | | | | | |
| 2 | OUM, 52-55 | ABN, 0.61 | 1.5016 | 3.83 | 1.5243 | 2.83 | 0.0227 | 21 |
| | bis-PGA, 20-21 | 85°, 30 min | | | | | | |
| | PPM5S, 8.5-9.0 | | | | | | | |
| | CHMA, 15-18 | | | | | | | |
| 3 | OUM, 32.8 | PI, 1.03 | 1.5011 | 3.97 | 1.5290 | 2.47 | 0.0276 | 38 |
| | bis-PGA, 16.64 | | | | | | | |
| | styrene, 16.79 | | | | | | | |
| | CHMA, 32.72 | | | | | | | |
| 4 | OUM, 34.03 | PI, 0.96 | 1.5082 | 3.87 | 1.5350 | 2.33 | 0.0268 | 67 |
| | bis-PGA, 31.18 | | | | | | | |
| | CHMA, 33.82 | | | | | | | |
| 5 | OUM-1, 53.11 | PI, 1.2 | 1.5016 | 3.83 | 1.5240 | 2.83 | 0.0224 | 20 |
| | bis-PGA, 20.03 | | | | | | | |
| | PPM5S, 9.32 | | | | | | | |
| | CHMA, 16.31 | | | | | | | |
| 6 | OUM-1, 39.46 | PI, 0.947 | 1.5011 | 3.7 | 1.5248 | 3.1 | 0.0237 | 23 |
| | bis-PGA, 20.17 | 4 min | | | | | | |
| | PPM5S, 9.42 | | | | | | | |
| | CHMA, 15.65 | | | | | | | |
| | OUP, 14.36 | | | | | | | |
| 7 | OUM-2, 39.81 | PI 0.892 | 1.5003 | 3.6 | 1.5228 | 3.13 | 0.0225 | 16 |
| | bis-PGA, 19.58 | 8 min | | | | | | |
| | PPM5S, 8.85 | and | | | | | | |
| | CHMA, 15.27 | 45°, 10 min | | | | | | |
| | OUP, 15.62 | | | | | | | |
| 8 | OUM-2, 53.22 | PI, 0.99 | 1.5015 | 3.8 | 1.5216 | 3.07 | 0.0201 | 12 |
| | bis-PGA, 19.64 | | | | | | | |
| | PPM5S, 8.85 | | | | | | | |
| | CHMA, 15.72 | | | | | | | |
| 9 | OUM-3, 70.6 | PI, 1.03 | 1.4881 | 3.90 | 1.5060 | 3.07 | 0.0178 | <0 |
| | PPM5S, 11.06 | ABN, | | | | | | |
| | BZMA, 18.36 | 0.944 | | | | | | |
| | | 2 + 2 min | | | | | | |
| | | +80°, 15 min | | | | | | |
| | | +85°, 15 min | | | | | | |
| 10 | OUM-3, 63.4 | PI, 0.92 | 1.4889 | 3.90 | 1.5057 | 3.23 | 0.0168 | <0 |
| | PPM5S, 9.93 | ABN, | | | | | | |
| | BZMA, 16.49 | 0.847 | | | | | | |
| | OUP, 10.2 | 2 + 2 min | | | | | | |
| 11 | OUM-3, 56.13 | PI, 0.824 | 1.4900 | 3.90 | 1.5046 | 3.47 | 0.0146 | <0 |
| | PPM5S, 8.8 | ABN, 0.75 | | | | | | |
| | BZMA, 13.87 | 2 + 2 min | | | | | | |
| | OUP, 20.5 | +80°, 15 min | | | | | | |
| | | +85°, 15 min | | | | | | |
| 12 | OUM-3, 39.67 | PI, 1.109 | 1.5007 | 3.8 | 1.5216 | 3.07 | 0.0209 | 12 |
| | bis-PGA, 19.04 | 8 min | | | | | | |
| | PPM5S, 7.71 | and | | | | | | |
| | CHMA, 7.08 | 45°, 10 min | | | | | | |
| | BZMA, 10.95 | | | | | | | |
| | OUP, 14.42 | | | | | | | |

*Photocuring: Hg lamp, 1,000 W, 4 min

It can be seen from the above that all the initial mixture systems, regardless of their refractive index, are characterized by the same value (within the error range) of Δnᵢₙᵢ˜3.8±0.2·10⁻⁴ of the temperature for the optical homogeneity of triplexes (Tₕₒₘ).

A powder of any desired known inorganic glass can be used as filler B), as long as it contains an inorganic photochromic compound.

Examples by way of illustration of silicate glasses include silicate glass containing AgHal, in particular AgCl, e.g. “Photogrey Extra™” (manufacturer Corning (USA)) or silicate glass containing CuHal, in particular CuCl₂, e.g. PHG-5 (manufacturer GOI, Russia).

In this context, the silicate glass “Photogrey Extra™” from Corning (USA) is particularly preferred.

In the present invention, the powder of the photochromic silicate glass is not subject to any particular limitations, and any desired known inorganic glass which is impregnated with any desired known inorganic photochromic compound can be used.

To improve the characteristic properties of the cured optical material with a filler content, e.g. the transparency and adhesion thereof, spherical photochromic filler particles are preferably used. The shape of these particles renders possible the production of high-quality triplexes, which are distinguished by good photochromic properties of the inner layer and good adhesion as well as simplicity and a high level of filler content.

Nevertheless, anisodiametric powder particles (the length exceeds the width 2 to 5 times) with sharp facets of irregular shape can be used. Examples by way of illustration include powders which are prepared by grinding photochromic AgCl-silicate glass “Photogrey Extram” from Corning (USA). The first two particle fractions having the size of from 0.25 to >0.16 and 0.16 to 0.1 mm can be used for the filler content of curable compositions.

The size (diameter) of the filler particles can vary widely, the preferred size of filler particles being about 0.1 to 0.05 mm. In this case, triplexes of high quality and adequate transparency in a broad temperature range can be produced.

To improve the characteristic properties of the filler B), e.g. its adhesion to the cured polymer, the filler B) is preferably treated with an adhesion promoter.

Any desired known adhesion promoters for silicate glasses e.g. can be used for this.

In the present invention, 3-(trimethoxysilyl)propyl methacrylate (1.5% strength solution in ethanol) is preferably used as adhesion promoter. This compound enters into sufficiently rigid chemical bonds with silicate glass specifically during hydrolysis. Due to the presence of the acrylate group, it is copolymerized with the matrix components.

A preferred process for treatment of the filler with an adhesion promoter envisages filtering out of fractions in the low size range having an average particle size of less than 0.05 mm, decanting several times, initially in water, then in ethanol, and contacting with an ethanol solution of an adhesion promoter, followed by drying at 60° C. until a constant weight is achieved.

In the present invention, a layer-for-layer process is preferably employed for coating the substrate surface with the curable composition. This process renders it possible to avoid intensive sorption of oxygen during mixing of the liquid oligomers and fillers as well as bubble formation.

For the preparation of high-quality photochromic optical materials, the filler B) is preferably introduced into the binder A), while at the same time the sample is heated to 40 to 50° C. Only in this case can evacuation of the liquid curable composition having a filler content be omitted.

In the present invention, the filler concentration is not subject to any particular limitations, but is preferably 1 to 75 wt. %, even more preferably 35 to 55 wt. %, based on the total amount of all the polymerizable components, in order to improve the quality of the cured optical material. This value depends to a moderate extent on the binder composition.

### EXAMPLES

The following examples serve to illustrate the invention in more detail and are not to be understood as a limitation.

The abbreviations and names of the compounds used are given in Table 1.

### Synthesis Example A

### Synthesis of Oligourethane Methacrylate (OUM)

500 g (0.5 mol) oligotetrahydrofuran-α,ω)-diol diisocyanate (Mn≈1,000), 140.8 g (1.1 mol) ethylene glycol monomethacrylate (MEG) and 9.0 g tin dilaurate were stirred at room temperature for 12 hours, until the NCO groups were completely consumed (IR spectrum data). Yield˜100%. Mn≈1,400; Mw≈1,600; Mw/Mn≈1.2; functionality˜2, d₄²⁰=1.086 kg.m⁻³; n_{D}²⁰=1.5095.

### Synthesis Examples B to D

### Synthesis of Oligourethane Methacrylates (OUM)

Oligourethane methacrylate (OUM) of the structures on page 11, 1. 3 and 4 were obtained from 500 g (0.5 mol) oligotetrahydrofuran-α,ω-diol diisocyanate in the same manner as in Example A using 1.1 mol of PPA5S (423.6 g) or PPM5S (398.2 g) instead of MEG.

### Synthesis Examples E to G

### Synthesis of the Plasticizers OUM-1, OUM-2 and OUP of the Formulae IV to VI

The plasticizers OUM-1, OUM-2 and OUP were obtained from 500 g (0.5 mol) oligotetrahydrofuran-α,ω-diol diisocyanate in the same manner as in Example A using 1.1 mol of a mixture of telogens and MEG and/or isopropanol:

0.73 and 0.37 mol structure (IV);
0.37 and 0.73 mol structure (V);
0.0 and 1.1 mol structure (VI).

### Example 1

### Preparation of a Curable Acrylate Binder

52 to 55 wt. % OUM, 20 to 21% bis-PGA, 8.5 to 9.0% PPM5S, 15 to 18% CHMA, 14.36% OUP and 1.1 to 1.2% PI were mixed with one another in a dark glass container.

The refractometric properties of the binder obtained are given in Table 2.

### Examples 2 to 12

### Preparation of Curable Acrylate Binders

The curable acrylate binders were prepared in the same manner as in Example 1, the quality and quantity of the components being given in Table 2.

The refractometric properties of the binder obtained are given in Table 2.

### Example 13

### Preparation of Curable Photochromic Compositions

39.45 wt. % OUM-1, 20.17% bis-PGA, 9.42% PPM5S, 15.65% CHMA, 14.36% OUP and 0.947% PI were mixed with one another in a dark glass container.

The filler-powder of photochromic AgCl-silicate glass “Photogrey Extra™” from Corning (USA) having a particle size of from 0.25 to 0.16—was pretreated by filtering out of fraction of small size, decanting several times first in water, then in ethanol and treatment with a 1.5% strength ethanol solution of an adhesion promoter, 3-(trimethoxysilyl)propyl methacrylate, followed by drying at 60° C. until a constant weight was achieved.

25 to 30 wt. % of the filler (based on the total amount of the liquid composition), which had been heated to 40 to 50° C., were added in small portions, with vigorous stirring, to the liquid curable binder, which was preheated to up to 40 to 50° C.

The curable composition having a filler content obtained was semitransparent on closer inspection, but the filler particles were visible in the perspective view.

### Examples 14 to 23

### Preparation of Curable Photochromic Compositions

The components of the liquid curable binders were mixed in a predetermined ratio (second column in Table 4) in the same manner as in Example 13. The filter-powder of photochromic AgCl-silicate glass from Corning (USA) having a particle size of from 0.25 to 0.16 or 0.16 to 0.1—was pretreated as above.

The stated amount of the filler, which was heated to 40 to 50° C. (third column in Table 4), was added in small portions, with vigorous stirring, to the liquid curable binder, which was preheated to 40 to 50° C.

For formation of a coating on a substrate surface, the preheated filler was added to the preheated liquid composition by means of a layer-for-layer process.

The properties of the compositions obtained are given in Table 4.

TABLE 4
Acrylate binders, curable photochromic compositions and cured
photochromic optical materials

| | | | Mixture | | Properties of the |
|---|---|---|---|---|---|
| | Binder | | properties | Curing | cured optical |
| No. | composition*, % | Filler** | before curing | conditions*** | material |
| 13 | OUM-1, 39.45 | C = 0.25-0.16 | close-up view - | hv, 4 min | good |
| | bis-PGA, 20.17 | A = 49.3 | transparent; | | transparency |
| | PPM5S, 9.42 | or | perspective | | iridescence |
| | CHMA, 15.65 | C = 0.16-0.1 | view - | | grey shade |
| | OUP, 14.36 | A = 40.06 | filler particles | | |
| | PI, 0.947 | | are visible | | |
| 14 | OUM-2, 39.81 | C = 0.25-0.16 | close-up view - | hv, 4 min | more cloudy |
| | bis-PGA, 19.58 | A = 49.55 | transparent; | +45°, 10 min | than in no. 3.1 |
| | PPM5S, 8.85 | or | perspective | | iridescence |
| | CHMA, 15.27 | C = 0.16-0.1 | view - | | grey shade |
| | OUP, 15.62 | A = 39 | filler particles | | |
| | PI, 0.892 | | are visible | | |
| 15 | OUM-2, 38.02 | C = 0.3-0.2 | semitransparent | hv, 15 min | sample is more |
| | bis-PGA, 21.45 | A = 70 or | with brown | | transparent than |
| | PPM5S, 10.50 | C = 0.2-0.1 | shade | | untreated |
| | OMA, 16.80 | A = 60 | | | sample, but |
| | styrene, 11.42 | or | | | brown; |
| | adhesive, 0.95 | C = 0.1-0.05 | | | iridescence |
| | PI, 1.25 | A = 60 | | | intensifies with |
| | | filler treated | | | increasing |
| | | with Na₂S₂O₃ | | | particle size; |
| | | | | | matrix is |
| | | | | | colorless |
| 6 | OUM-3, 70.6 | C = 0.16-0.25 | close-up view - | hv, 4 min | sample is |
| | PPM5S, 11.06 | A = 25-30 | transparent; | +90°, 15 min | cloudy; |
| | BZMA, 18.36 | | perspective | | poor adhesion to |
| | ABN, 0.944 | | view - cloudy | | the filler |
| | PI, 1.03 | | | | |
| 17 | OUM-3, 39.67 | C = 0.25-0.16 | close-up view - | hv, 4 min | close-up view - |
| | bis-PGA, 19.04 | A = 49.55 | transparent; | +45°, 10 min | transparent; |
| | PPM5S, 7.71 | or | perspective | | perspective |
| | CHMA, 7.08 | C = 0.16-0.1 | view - cloudy | | view - cloudy; |
| | BZMA, 10.5 | A = 39.9 | | | intense |
| | OUP, 14.42 | | | | iridescence |
| | PI, 1.109 | | | | |
| 18 | OUM, 37.94 | C = 0.25-0.16 | | hv, 16 min | sample is grey |
| | bis-PGA, 21.77 | A = 50-70 | | | after the curing |
| | OMA, 21.43 | | | | |
| | N-VP, 16.79 | | | | |
| | adhesive, 0.94 | | | | |
| | PI, 1.13 | | | | |
| 19 | OUM, 52.66 | C = 0.3-0.2 | many bubbles | hv, 4 min | samples are |
| | bis-PGA, 19.25 | A = 68.5 | | | transparent; |
| | PPM5S, 8.76 | or | | | grey shade; |
| | CHMA, 18.31 | C = 0.2-0.1 | | | bubbles close to |
| | PI, 1.22 | A = 62-65 | | | the surface of |
| | | or | | | the cover glass |
| | | C = 0.1-0.05 | | | |
| | | A = 63.5 | | | |
| | | fraction mixture | | | |
| 20 | OUM, 54.91 | C = 0.3-0.2 | semitransparent | hv, 4 min | sample with |
| | bis-PGA, 19.87 | A = 25-30 | | | excellent |
| | PPM5S, 9.0 | | | | transparency |
| | CHMA, 15.22 | | | | |
| | PI, 0.98 | | | | |
| 21 | OUM, 54.91 | C = 0.3-0.2 | semitransparent | hv, 4 min | excellent |
| | bis-PGA, 19.87 | or | | | sample; |
| | PPM5S, 9.0 | C = 0.2-0.1 | | | sample slightly |
| | CHMA, 15.22 | or | | | colored; |
| | PI, 0.98 | C = 0.1-0.05 | | | slight |
| | | A = 55 | | | iridescence; |
| | | | | | practically no |
| | | | | | bubbles |
| 22 | OUM, 54.73 | C = 0.3-0.2 | semitransparent | hv, 4 min | excellent |
| | bis-PGA, 19.87 | or | | | sample; |
| | PPM5S, 8.91 | C = 0.1-0.05 | | | matrix shows |
| | CHMA, 15.37 | A = 55 | | | good adhesion |
| | PI, 1.1 | | | | to PC film and |
| | | | | | silicate glass; |
| | | | | | sample slightly |
| | | | | | colored; |
| | | | | | practically no |
| | | | | | bubbles |
| 23 | OUM, 54.75 | C = 0.3-0.2 | semitransparent | 85°, 30 min | excellent |
| | bis-PGA, 21.38 | or | | | sample; |
| | PPM5S, 8.91 | C = 0.1-0.05 | | | matrix shows |
| | CHMA, 14.35 | A = 55 | | | good adhesion |
| | ABN, 0.61 | | | | to PC film and |
| | | | | | silicate glass; |
| | | | | | sample slightly |
| | | | | | colored; |
| | | | | | practically no |
| | | | | | bubbles |
| 41 | OUM, 54.0 | C = 0.35-0.20 | close-up view - | hv, 4 min | good |
| | bis-PGA, 20.0 | A = 50.0 | transparent; | | transparency; |
| | PPM5S, 10.0 | | perspective | | grey shade |
| | CHMA, 15.0 | | view - filler | | |
| | PI, 1.0 | | particles are | | |
| | | | visible | | |

*The key to the binder components is given above.
**C - filler particle size in mm, A - weight content of the fraction in %
***hv - irradiation by means of a high pressure Hg lamp, 1,000 W

### Example 24

### Preparation of a Cured Photochromic Optical Material by Photochemically Initiated Polymerization

The liquid curable composition given in Example 13 was irradiated on the surface of a silicate or polycarbonate glass with a high pressure mercury vapor lamp with an output of 1,000 W for 4 minutes.

In some cases, the sample was additionally heated at 45° C. for 10 to 15 minutes for complete three-dimensional polymerization.

The particular properties of the cured materials are given in Table 4.

### Example 25 to 28

### Preparation of Cured Photochromic Optical Materials by Photochemically Initiated Polymerization

The liquid curable compositions given in Examples 14 to 22 were treated as described in Example 24, in order to prepare the cured photochromic optical materials given in Table 4.

The particular properties of the cured materials are given in Table 4.

### Example 29

### Preparation of a Cured Photochromic Optical Material by Thermally Initiated Polymerization

The liquid curable composition given in Example 23 was heated at 85° C. on the surface of silicate or polycarbonate glass for 30 minutes.

The particular properties of the cured materials are given in Table 4.

### Example 30

### Production of a Photochromic Polycarbonate Triplex by Thermally Initiated Polymerization

The curable photochromic composition described in Example 13 was treated in the same manner as in Example 24, but between two polycarbonate glasses;

The particular properties of the triplex obtained are given in Table 4.

### Examples 31 to 39

### Production of a Photochromic Polycarbonate Triplex by Photochemically Initiated Polymerization

The curable photochromic compositions described in Examples 14 to 22 were treated in the same manner as in Example 24, but between two polycarbonate glasses.

The particular properties of the triplex obtained are given in Table 4.

### Example 40

### Production of a Photochromic Polycarbonate Triplex by Thermally Initiated Polymerization

The curable photochromic composition described in Example 24 was treated in the same manner as in Example 29, but between two polycarbonate glasses.

The particular properties of the triplex obtained are given in Table 4.

### Example 41

### Preparation of a Curable Photochromic Composition Based on Photochromic CuCl Glasses

54.0 wt. % OUM, 20.0% bis-PGA, 10.0% PPM5S, 15.0% CHMA and 1.0% PI were mixed with one another in a dark glass container.

The filler-powder of photochromic PHG-5 glasses based on photosensitive CuCl microcrystals from GOI (Russia) having a particle size of from 0.35 to 0.20—was pretreated in the same manner as in Example 13.

50 wt. % of the filler (based on the total amount of the liquid composition), which was heated to 40 to 50° C., were added in small portions, with vigorous stirring, to the liquid curable binder, which was preheated to up to 40 to 50° C.

The properties of the compositions obtained are given in Table 4.

### Example 42

### Preparation of a Cured Photochromic Optical Material by Photochemically Initiated Polymerization

The liquid curable composition given in Example 41 was irradiated on the surface of silicate or polycarbonate glass with a high pressure mercury vapor lamp with an output of 1,000 W for 4 minutes.

Additional heating at 45° C. for 10 to 15 minutes was carried out for complete three-dimensional polymerization.

The particular properties of the cured material are given in Table 4.

### Example 43

Production of a Photochromic Polycarbonate Triplex by Photochemically Initiated Polymerization

The curable photochromic composition described in Example 41 was treated in the same manner as in Example 42, but between two polycarbonate glasses.

The particular properties of the triplex obtained are given in table 4.

As described above, a photochromic cured material which has excellent photochromic properties, in particular long-term use of photochromic objects, and excellent optical properties, such as e.g. colorlessness and transparency, can be obtained from the curable composition according to the invention. Furthermore, the cured product has outstanding elasticity and impact strength for use as a coating on various substrates or the inner layer of photochromic triplexes.

Since the curable composition according to the invention has the above excellent characteristic properties, it is particularly suitable as an inner layer of photochromic polycarbonate triplexes.

A photochromic optical material having excellent long-term stability of the photochromic properties can be obtained by using powder of an inorganic photochromic glass as a filler for the curable acrylate composition. The optical properties of cured optical material can furthermore additionally be improved by pretreating the filler with an adhesion promoter. The preparation process according to the invention for photochromic optical materials is particularly suitable as a process for providing a photochromic optical material which has excellent photochromic and optical properties.

1. Curable composition comprising at least:
A) 20 to 98.99 wt. % of one or more acrylic compounds capable of undergoing free-radical polymerization;
B) 1.0 to 70 wt. % of a powder of silicate glass, which contains an inorganic photochromic compound; and
C) 0.01 to 10 wt. % of a polymerization initiator.

2. Curable composition according to claim 1, wherein the one or more acrylic compounds A) comprise:
A1) 20 to 80 wt. % of one or more oligomers having two (meth)acryl groups and a refractive index of less than 1.51;
A2) 5 to 50 wt. % of one or more oligomers with two (meth)acryl groups and a refractive index greater than 1.53; and
E) 1 to 30 wt. % of a polymerizable solvent.

3. Curable composition according to claim 2, wherein the one or more oligomers A1) include an oligomer having two (meth)acryl groups which are bonded via a divalent radical without aromatic groupings.

4. Curable composition according to claim 2, wherein the one or more oligomers A2) include an oligomer having two (meth)acryl groups which are bonded via a divalent radical with aromatic groupings.

5. Curable composition according to claim 1, further comprising a plasticizer D).

6. Curable composition according to claim 2, wherein the one or more oligomers A1) include at least one of the formula (I) 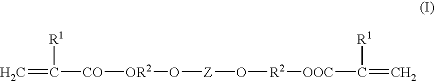
wherein
R¹ is a hydrogen or fluorine atom or a methyl group;
R² is a divalent organic radical group: 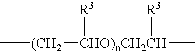
wherein
R³ is a hydrogen atom or a methyl group; and
n is an integer from 0 to 10;
X is a divalent organic radical group with the ester, carbonate or urethane grouping:
—Y—R⁴—Y—
wherein
Y is the divalent group —CO—, —COO—, —CONH—R⁵— or —R⁵NHCO—;
R⁴ is a divalent organic radical group: 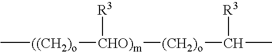
wherein
o is an integer from 1 to 3, m is an integer from 1 to 250;
R⁵ is a divalent organic radical group: 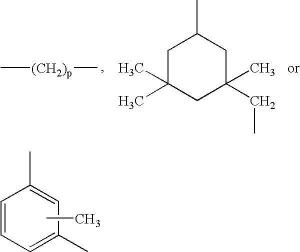
where
p=4 to 12, preferably 6.

7. Curable composition according to claim 2, wherein said one or more oligomers A2) include at least one of the formula (II) 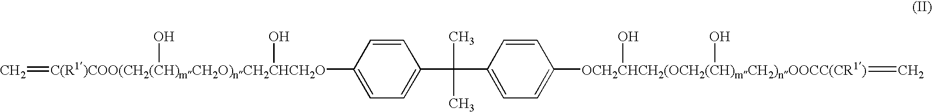
wherein
R^{1′} is a hydrogen atom or a methyl group, n″ is an integer from 1 to 20 and m″ is an integer from 0 to 1.

8. Curable composition according to claim 5, wherein said plasticizer D) comprises at least one of the formula (III) 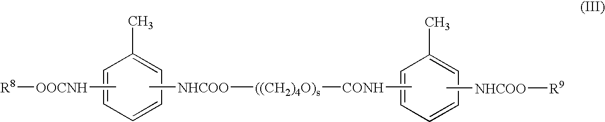
wherein R⁸ and R⁹ independently of one another represent —(CH₂)₂OOCC(CH₃)═CH₂ or a linear or branched C₁ to C₁₈-alkyl radical, but wherein the group —(CH₂)₂OOCC(CH₃)═CH₂ occurs only at most once in formula (III), and s represents 15 to 20.

9. Curable composition according to claim 5, wherein R⁸ and R⁹ independently of one another represent —CH(CH₃)₂, or a C₅ to C₁₂-cycloalkyl radical.

10. Curable composition according to claim 1, wherein the filler B) is a photochromic compound selected from the group consisting of halides of the elements of the first sub-groups of the periodic table of the elements.

11. Curable composition according to claim 10, wherein said filler B) is a copper halide or silver halide.

12. Curable composition according to claim 11, wherein said filler B) is copper chloride or silver chloride.

13. Curable composition according to claim 1, wherein the filler B) is in spherical form.

14. Curable composition according to claim 1, wherein the filler B) comprises particles having a diameter of from 0.05 to 0.1 mm.

15. A photochromic cured product obtained by curing a curable composition of claim 1.

16. Product according to claim 15, wherein curing forms polyacrylic compounds from the one or more acrylic compounds A) and the polyacrylic compounds formed from the one or more compounds A have a refractive index which deviates from the refractive index of the filler B) by not more than 0.02.

17. A photochromic optical material comprising a substrate having at least one surface coated with a cured product of a curable composition of claim 1.

18. A polycarbonate triplex comprising at least one layer of cured curable composition of claim 1.

19. Process for the preparation of a photochromic optical material which comprises at least one substrate having at least one coated surface, comprising applying a film of a curable composition to at least one surface of said substrate and curing said film with light or heat or both light and heat.

20. Process according to claim 19, comprising the step of layer-for-layer coating of at least one surface of a substrate with a curable composition comprising at least:
A) 20 to 98.99 wt. % of one or more acrylic compounds capable of undergoing free-radical polymerization;
B) 1.0 to 70 wt. % of a powder of silicate glass, which contains an inorganic photochromic compound; and
C) 0.01 to 10 wt. % of a polymerization initiator.

21. Process for the production of a photochromic triplex, which comprises applying a layer of a curable composition of claim 1 between two substrates and curing with light or heat, or with both light and heat.
